(19) United States
(12) Patent Application Publication
(10) Pub. No.: US 2026/0329840 A1
(43) Pub. Date: Oct. 22, 2026

(54) METHOD FOR GENERATING CUSTOM INDEX, INDEX EDITOR, ELECTRONIC DEVICE AND STORAGE MEDIUM

(71) Applicant: PATSNAP PTE. LTD., Singapore (SG)

(72) Inventors: Jinlong YANG, Singapore (SG); Yulong WANG, Singapore (SG); Zhiqiang HUAN, Singapore (SG); Jing HEI, Singapore (SG); Yi WANG, Singapore (SG); Shuyi CUI, Singapore (SG); Xuanyang DONG, Singapore (SG); Xi ZHOU, Singapore (SG)

(73) Assignee: PATSNAP PTE. LTD., Singapore (SG)

(21) Appl. No.: 19/103,537

(22) PCT Filed: Nov. 14, 2024
(86) PCT No.: PCT/CN2024/131959

§ 371 Date: Feb. 12, 2025

(30) Foreign Application Priority Data
Sep. 14, 2023 (CN) 202311188853.8

(51) Int. Cl. G06F 16/22; G06F 9/451

(52) U.S. Cl. CPC G06F 16/2291; G06F 9/453

(57) ABSTRACT

A method for generating a custom index includes: determining at least one first-order operator, and determining a data processing rule corresponding to each first-order operator in the at least one first-order operator, the first-order operator being an index of basic category or custom category; and generating the custom index based on the at least one first-order operator and the data processing rule corresponding to each first-order operator, and the custom index being of custom category; wherein the custom index can serve as the first-order operator, to generate a new custom index. The present application can create a custom index, to meet data analysis requirements of different industries and fields.

### CROSS-REFERENCE TO RELATED APPLICATIONS

This application is a national stage of International Application No. PCT/CN2024/131959, filed on Nov. 14, 2024, which claims priority to Chinese Patent Application No. 202311188853.8, filed on Sep. 14, 2023. All of the aforementioned applications are hereby incorporated by reference in their entireties.

### TECHNICAL FIELD

The present disclosure relates to the fields of data processing and index editing, and in particular, to a method for generating a custom index, an index editor, an electronic device and a computer readable storage medium.

### BACKGROUND

Traditional methods are usually restricted to a set of fixed parameter indexes in the fields of data analysis and statistics, which are used for generating graphic and data analysis, but a custom index cannot be generated according to specific data and requirements. This restriction results in inflexibility of data analysis, because only pre-defined and limited parameter indexes can be selected to make analysis. Therefore, a more flexible method is needed, to meet requirements of data analysis and statistics under different scenarios.

Based on this, the present disclosure provides a method for generating a custom index, an index editor, an electronic device and a computer readable storage medium to improve related technologies.

### SUMMARY

The aim of the present application is to provide a method for generating a custom index, an index editor, an electronic device and a computer readable storage medium, in which a customized custom index is created to meet data analysis requirements of different industries and fields.

In a first aspect, the present application provides a method for generating a custom index, including: determining at least one first-order operator, and determining a data processing rule corresponding to each first-order operator of the at least one first-order operator, the first-order operator being an index of basic category or custom category; and generating the custom index based on the at least one first-order operator and the data processing rule corresponding to each the first-order operator, the custom index being of custom category. The custom index can serve as the first-order operator, to generate a new custom index.

In a second aspect, the present application discloses an index editor used to provide a custom index generating interface, including: a combo box configured to receive first text entry operations and/or first selection operations performed by a user, to determine at least one first-order operators; a formula edit box configured to display each first-order operator of the at least one first-order operator determined by the user through an operator control, and to receive rule selection operations performed by the user for a drop-down list box of the operator control, to determine a data processing rule corresponding to each the first-order operator; and an index generating button configured to generate a custom index based on the at least one first-order operator and the data processing rule corresponding to each the first-order operator upon being clicked, the custom index being of custom category. The custom index can serve as the first-order operator, to generate a new custom index.

In a third aspect, the present application provides an electronic device including a memory and at least one processor. The memory stores a computer program therein, the at least one processor is configured to execute the computer program, to perform any step of the above-mentioned method or any function of the above-mentioned index editor.

In a fourth aspect, the present application provides a computer readable storage medium storing a computer program thereon. When executed by at least one processor, the computer program can cause the at least one processor to perform any step of the above-mentioned method or any function of the above-mentioned index editor.

The present application provides a method for generating a custom index, an index editor, an electronic device and a computer readable storage medium, in which a customized custom index to meet data analysis requirements of different industries and fields. A new index may be generated by performing combination and operation of different operators, to perform further data analysis and visualization. The benefit of this is that, a user may select different first-order operators according to specific requirements and purposes of analysis, and thus a fully customized custom index is created, which improves flexibility of an analysis tool, such that it can be adapted to data analysis requirements of different industries and fields; the user may acquire more data analysis results at different levels and dimensions by the method for generating a custom index, but not to be limited to pre-defined and fixed parameter indexes, which helps to dig deeper into data. In summary, according to the present application, data analysis capability is improved and multi-scenario data analysis is supported by enhancing flexibility and customization.

### BRIEF DESCRIPTION OF THE DRAWINGS

The present application will be further interpreted with reference to the accompanied drawings and embodiments below.

FIG. 1 is a flowchart of a method for generating a custom index according to an embodiment of the present application.

FIG. 2 is an interface schematic diagram of an index editor according to an embodiment of the present application.

FIG. 3 is a structural block diagram of an electronic device according to an embodiment of the present application.

### DETAILED DESCRIPTION OF THE EMBODIMENTS

Technical solutions according to embodiments of the present disclosure will be described clearly and comprehensively below with reference to the drawings of the present disclosure. Apparently, the described embodiments are only a portion, but not all of the embodiments of the present disclosure. All other embodiments obtained by those skilled in the art based on embodiments in the present disclosure without creative work will fall within the scope of the present disclosure.

It should be noted that, in description of embodiments of the present application, the terms such as “first”, “second” are only used for descriptive purposes, not to be understood as indicate or imply relative importance or indicate implicitly the number of the stated technical features. Therefore, features, which are defined by “first”, “second”, may explicitly or implicitly include one or more stated features. In the description of embodiments of the present application, the meaning of “a plurality of” represents two or more, unless otherwise specified clearly.

In the context of data analysis and processing, a user usually needs to handle various indexes and data. The data may include different types of indexes such as numeric, character, time, geography, etc. Related technologies provide some basic data processing functions, but they only support to perform data processing on existed indexes, which cannot meet the user's customized and complicated requirements. Moreover, a configured interface becomes complicated, which makes the user devote much time and energy to understand and configure an index, and thus the user cannot create and edit a custom index according to his/her specific requirements, and thereby the configured interface may be difficult to understand and use, and the user needs to learn and be trained.

Therefore, it is necessary to consider how to provide a more flexible, customized and user-friendly method to generate and edit an index. The present application may include the following key elements.

First-order operators and second-order operators: concepts of the first-order operators and the second-order operators are introduced, to better organize and manage data processing rules of indexes.

Data processing rules: rich data processing rules are provided, to meet various data types and requirements.

A visualized editing tool: a user-friendly and custom index generating interface is created, and a user can be easy to configure and edit an index through elements such as a tab, a combo box, and a formula edit box, etc.

A tooltip control: a prompt message is increased, to help a user better understand and use first-order operators and second-order operators.

Particularly, the present application provides a method for generating a custom index, an index editor, an electronic device and a computer readable storage medium, such that a user can create and edit custom indexes according to his/her specific requirements. These custom indexes may include various data processing and operation rules, and thus the user can flexibly perform data analysis and processing, which improves the user's experience and efficiency of data processing.

It should be noted that, although a patent data analysis scenario in the field of data analysis is taken as an example of the present application, the present application may be applied to other data analysis scenarios in the field of data analysis, for example, financial analysis, medical and healthcare data analysis, marketing analysis, supply chain management, and so on. The present application is not limited thereto. For data analysis in different fields, different types of data and indexes are usually needed to be handled. Therefore, in the present application, flexibility and customizability can make it easy to meet requirements of different fields.

In patent field, a powerful data analysis tool is provided for research and development personnels and patent agents, such that a plurality of custom indexes are created according to specific requirements of patent data, this helps to predict patent trends, assess risk and manage intellectual property.

In financial field, financial analysts may be helped to create various financial indexes according to market conditions and customer demands, to predict patent trends, assess risk and allocate assets.

In medical and healthcare field, medical data usually includes patients' physiological indexes, medical record data and medical image data, etc. Physicians and developers may create custom indexes for disease diagnosis, treatment monitoring, and clinical research.

In marketing field, market analysts may create different market indexes according to the present application for customer subdivision, advertising effectiveness analysis and market trend forecasting.

In supply chain management field, supply chain professionals may create custom indexes according to the present application, to track all aspects of supply chain operations, including inventory management, transportation efficiency and supplier performance. Because a supply chain involves multiple links and indexes, the custom indexes according to the present application may help supply chain management personnels to better accommodate to different supply chains.

A data analysis system is provided according to an embodiment of the present application. The data analysis system may include a client and a server, the client may be an electronic device having a capability of accessing the network. In particular, for example, the client may be a desktop computer, a tablet, a laptop, a smartphone, a digital assistant, a smart wearable device, a shopping guide terminal, a TV set, a smart speaker, a microphone, etc. The smart wearable device includes, but not limited to a smart bracelet, a smart watch, smart glasses, a smart helmet, a smart necklace, etc. In addition, the client may also be a software which can run in the electronic device. The server may be an electronic device having certain operational and processing capability, which may have a network communication module, a processor, a storage, etc. Of course, the server may also be a software which runs in the electronic device. The server may also be a distributed server, may be a system that work together such as multi-processors, storages, network communication modules, etc. Moreover, the server may also be a server cluster formed by several servers. With the development of science and technology, the server may also be new technical means by which respective functions according to an embodiment of the present application can be achieved. For example, the server may be a new form of “server” performed based on quantum computation.

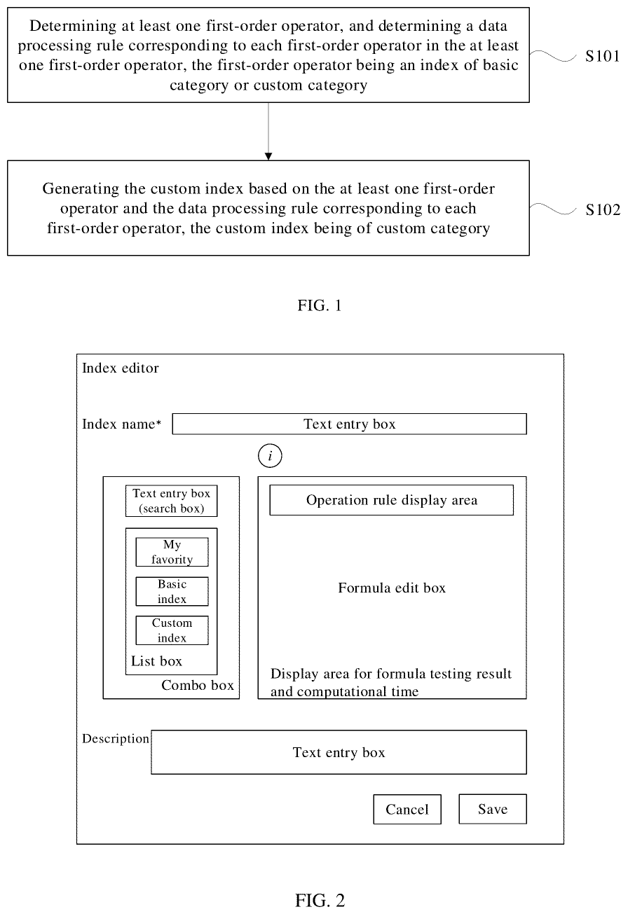

With reference to FIG. 1, FIG. 1 is a flow schematic diagram of a method for generating a custom index according to an embodiment of the present application. The method includes the following steps.

Step S101: determining at least one first-order operator, and determining a data processing rule corresponding to each first-order operator in the at least one first-order operator. The first-order operator is an index of basic category or custom category.

Step S102: generating the custom index based on the at least one first-order operator and the data processing rule corresponding to each first-order operator. The custom index is an index of custom category.

The custom index can serve as the first-order operator, to generate a new custom index.

In some possible embodiments, when at least one first-order operator includes a plurality of first-order operators (i.e. the number of the first-order operators used to generate custom indexes is larger than 1), the method further includes: determining operation rules among the plurality of first-order operators. The generating the custom index based on the at least one first-order operator and the data processing rule corresponding to each first-order operator (i.e. Step S102), includes: generating the custom index based on the plurality of first-order operators, the data processing rule corresponding to each the first-order operator, and the operation rules among the plurality of first-order operators.

An index of basic category according to the present application is not limited thereto. In patent data analysis field, it, for example, may be a receiving office, applicant, inventor, agency, patent agent, application date, grant date, priority date, application number, publication number (announcement number), patent abstract, patent title, patent type, patent classification number, citations, number of claims, first claim, patent legal status, international patent classification, patent examiner, patent priority, patent litigation information, patent transfer information, citation count for a patent, backward citation count for a patent, patent family members, patent technology field classification, patent application field classification, etc. Generally speaking, the index of basic category is that provided by default in a data analysis system.

The first-order operators are basic constitutional units used to create custom indexes. The first-order operators may be indexes of basic category (for example, applicant, grant date, etc.), and may also be indexes of custom category (for example, average patent value of each inventor). For the first-order operator (whether an index of basic category or a custom category), it is necessary to determine a data processing rule, which indicates what kind of useful information based on the index should be extracted from a set of to-be-processed data. In addition, after determining one first-order operator, a secondary filtration may also be performed on the set of to-be-processed data of the first-order operator by using a second-order operator. In other words, the first-order operator may be used with the second-order operator, to perform more complicated data filtering and processing tasks.

Each data processing rule is a data processing method corresponding to one first-order operator, for performing operation and transformation on index data. Different types of indexes may correspond to different data processing rules, for example, averaging, summing, counting, etc. As an example, for the “patent value” of a first-order operator, its data processing rule may be summing, in order to determine a sum of patent values. If conversion between monetary units is required (for example, USD is converted into RMB), a computation may be performed based on the exchange rate between currencies. The exchange rate may be a numerical value entered by a user, a system default numerical value, or an exchange rate numerical value read from a data interface in real time.

The operation rules define operations among the first-order operators, which includes operator and an operational precedence (represented as an operational level). Custom indexes are generated based on the operation rules, by which results of different first-order operators are combined. For example, if it is necessary to generate a custom index to calculate a value score of each patent, a value score of a patent may be added to or multiplied by other indexes by using arithmetic operators.

The custom index is a new index generated based on the first-order operator and its data processing rule. These custom indexes usually reflect a user's specific analysis needs. As an example, a custom index may be “a comprehensive value of a patent”, which is formed by combining indexes such as a value score of a patent, citation count, etc. In some possible embodiments, the custom index corresponds to a formula and is used to indicate what kind of data processing rules should be performed on a set of to-be-processed data. As an example, the formula is as follows: number of patents (summing)/inventors (de-duplication counting), average number of patents of each inventor is calculated based on the formula.

For example, when it is required to create a custom index to compute average number of patents of each inventor, the above-mentioned method may be used. In the initial stage, patent data of a specific applicant is screened from a patent database as a primary filtering result by establishing a search query and executing it. Firstly, two first-order operators and their corresponding data processing rules are determined.

A first-order operator 1 refers to “a patent value”, which is an index of custom category and represents a value of each patent. A data processing rule 1 refers to “summing”, which represents calculation of a sum of patents values of all patents corresponding to the primary filtering result.

A first-order operator 2 refers to “inventor”, which is an index of basic category and represents inventor of each patent. A data processing rule 2 refers to “de-duplication counting”, which represents a total number of inventors obtained by de-duplication counting inventors of all patents and then adding them.

The operation rule is “division”, which represents that a data processing result (i.e. a sum of a patent value) of the first-order operator 1 (i.e. a patent value) is divided by a data processing result (i.e. number of inventors) of the first-order operator 2 (i.e. an inventor), to compute and get an average patent value of each inventor.

A custom index, i.e. “average patent value of each inventor”, may be generated by using the above-mentioned method, a data processing result of the custom index will be calculated based on the primary filtering result, two first-order operators, and a division operator. The formula is as follows: patent values (summing)/inventors (de-duplication counting). The custom index may help an enterprise each inventor's evaluate average contribution to the patented invention, to gain a more comprehensive understanding of performance of an innovative team.

Therefore, firstly, at least one first-order operator is determined, these operators may be indexes of basic category (i.e. basic indexes) or user-defined indexes. Each first-order operator corresponds to a data processing rule which defines how to handle raw data for this operator, for example, a data processing result of each first-order operator is determined based on a known primary filtering result (for example, an authorized patent of a specific applicant), a first-order operator (for example, a patent value) and its data processing rule (for example, summing). When the number of first-order operators used to generate custom indexes is larger than 1, operation rules among the first-order operators are also to be determined. These rules represent how to combine different first-order operators together to perform computation, and may include operation rules such as addition, subtraction, multiplication, division, and operation levels, etc., and these rules define how to generate custom indexes. Next, a custom index is generated based on selected first-order operators and their data processing rules and operation rules therebetween (if any). These custom indexes are of custom category, and their formulas are determined based on each first-order operator and its data processing rule (may also include operation rules among first-order operators), in other words, a data processing result of each custom index is determined by a data processing result of each first-order operator (probably also involving operation rules among first-order operators). A new index may be generated by combining and operating different operators, to perform further data analysis and visualization.

The benefit of this is that, a user may select different first-order operators, data processing rules, and operation rules according to specific requirements and the purpose of analysis, and thus a fully customized custom index is created, which improves flexibility of an analysis tool, such that it can be adapted to data analysis requirements of different industries and fields; the user may acquire more data analysis results at different levels and dimensions by a method for generating a custom index, but not to be limited to pre-defined and fixed parameter indexes, which helps to dig deeper into data. In summary, the method riches data analysis capability, supports multi-scenario data analysis, and improves decision-making capability by enhancing flexibility and customization.

It should be noted that, when the number of the first-order operators is larger than 1, it is required to determine the operation rules among the first-order operators; when the number of the first-order operators is 1, the operation rules among the first-order operators are not involved.

In some possible embodiments, a process of determining at least one first-order operator includes: receiving one or more first selection operations performed by a user on an index set via a terminal device, to determine one or more first-order operators; or receiving one or more first text entry operations performed by the user via a terminal device, and identifying the one or more first-order operators based on received one or more first text entry operations; or importing the one or more first-order operators from an index sharing platform; or providing a first chatbot human-computer interface via a terminal device, to receive one or more first input information from a user; and extracting semantics from the one or more first input information, to determine the one or more first-order operators.

The terminal device refers to a device by which a user interacts with a data analysis system, such as a personal computer, a smartphone, a tablet, etc.

The first selection operations refer to selections performed by a user on the terminal device, to select one or more first-order operators. These operations may be interactions on a user interface, such as clicking, dragging and dropping, etc. As an example, a user clicks an “application data” button on an application interface, to perform a first selection operation.

The first text entry operations represent that a user enters a text message on the terminal device, to identify and determine one or more first-order operators. As an example, a user enters a text message of “patent value” into a search bar, to identify a first-order operator of “patent value”.

The index sharing platform refers to an on-line platform used to store and share index data, and a user may import each first-order operator from it, to generate a custom index.

The first chatbot human-computer interface refers to an interface, by which a user may have a conversation with a chatbot, to perform each first input information operation, and thus a first-order operator is identified and determined. As an example, when a user has a conversation with a chatbot, an instruction relevant with an index selection will be provided. An appropriate first-order operator is obtained by extracting semantics from a Large Language Model and deducing.

Extracting semantics refers to a process of identifying and understanding the meaning of input information provided by a user, to determine a first-order operator.

The first input information, for example, is text information, audio information, image information, etc. As an example, text information from a user may be identified by natural language processing to determine a first-order operator, for example, after extracting semantics “screen European and American patents”, a corresponding first-order operator “receiving office” is obtained.

In the following example, four methods will be employed to interpret how to determine at least one first-order operator.

First Method: a selection interface including a plurality of indexes is provided. A user selects a first-order operator by ticking a checkbox on an interface. For example, the user ticks “application date” and “patent value” as first-order operators, these selections are to be used for generating custom indexes.

Second Method: a user enters text information “value” into a search box (or a combo box). By matching keywords, it is identified that the user hopes to take “patent value” as a first-order operator.

Third Method: a user imports two custom indexes from an index sharing platform, such as “average patent value of each inventor”, “top 10 applicants in number of patents”. These two imported custom indexes are first-order operators, and are used for generating new custom indexes.

Fourth Method: a user opens a first chatbot interface, and makes the following request to a chatbot: “I need to calculate a sum of patent values”. Upon extracting semantics, a first-order operator of “patent values” is obtained, and “summing” is selected as a data processing rule corresponding to the “patent values”.

These examples exhibit how a user determines at least one first-order operator through different methods.

Therefore, determining at least one first-order operator offers a basis for generating a custom index.

In particular, the first selection operations performed by the user for the index set may be received by the terminal device. The user may select one or more indexes from an existed index set, and these selected indexes will provide a basis for first-order operators. This method allows the user to select indexes directly from an available index list, and take them as a basis for generating custom indexes.

Another method is to receive first text entry operations performed by a user via a terminal device. One or more first-order operators are identified and generated based on a text entered by a user. The user may enter a name or description of a specific operator, and a corresponding first-order operator is identified and generated based on entered contents. This method allows the user to describe a required first-order operator by a form of text, such that a corresponding first-order operator is quickly identified.

In addition, the user may import one or more first-order operators from index sharing platforms. These sharing platforms may include first-order operators created and shared by other users, and the user may select to import these first-order operators and employ them to generate custom indexes.

Moreover, the first chatbot human-computer interface may also be provided, to receive a user's first input information. The information may include the user's requirement description or question statement. Semantics are extracted, and one or more first-order operators are determined based on the user's input information. This method allows the user to interact with a system in a form of natural language, and is more intelligent and user-friendly.

The benefit of this is that, a first-order operator may be determined by a user based on a selection, a text entry, importing from index sharing platform, or a natural language interaction, the diversity of input methods is more user-friendly, to meet different users' requirements and customs, such that a first-order operator may be determined by the user based on the user's own needs and preferences; the technical threshold is reduced, and a custom index can also be easily created by a user who is not familiar with the technical field, and thus availability and wide application of a system are improved; semantics are extracted by using the first chatbot human-computer interface, the chatbot is more intelligent, the natural language entered by the user may be understood, and useful information is extracted, to determine a first-order operator, and thus convenience of user interaction is increased.

In some possible embodiments, a process of determining a data processing rule corresponding to each first-order operator in the at least one first-order operator, includes: performing the following processing for each first-order operator: determining one data processing rule in a set of data processing rules as that of the first-order operator based on the set of the data processing rules corresponding to data types of the first-order operators; the data types of the first-order operators are as follows: numerical value, character, time, or geography.

Each first-order operator has a specific data type, and it is required to designate one data processing rule (or use a default value) as a basis for generating a custom index.

The data type refers to a classification of information nature of a first-order operator, it may be a numerical value, a character, time, or a geography. The numerical value represents information that may be expressed by a number, such as a patent value. The character represents that a text or a character string is included, such as an applicant, a classification number. The time represents a date and relevant information, such as an application date. The geography represents information relevant with a geographic position, such as a receiving office, an applicant address.

The data processing rule is a specification which defines how to process and compute data of a first-order operator, and it particularly depends on a data type of the first-order operator.

For example, it is assumed that a custom index “average number of patents of each inventor” is to be generated. If it is necessary to compute average number of patents of each inventor, the number of patents and the number of inventors shall be computed respectively.

Firstly, “number of patents” and “inventors” are selected as first-order operators.

A data type of “number of patents” is a numerical value, “counting” is selected as a data processing rule, to get the number of patents.

A data type of “inventors” is a character, “de-duplication counting” is selected as a data processing rule, to get the number of inventors.

An arithmetic operator “division” is applied to two first-order operators: “number of patents” and “inventors”, to generate a custom index “average number of patents of each inventor”.

Thus, a process of determining a data processing rule of each first-order operator includes the following steps: firstly, a data type of each first-order operator is determined, the type may be a numerical value, a character, time, or a geography (also called as “territory”). The aim is to identify what type of data the operator will process. Secondly, there is a set of data processing rules for each data type to defines how to process data of this type, including various computing methods, formatting methods, etc. One data processing rule is selected from a corresponding set of data processing rules based on a data type of the first-order operator, and the one data processing rule is determined as that of this first-order operator. One method of determining one data processing rule from a set of data processing rules for example is that a user specifies a data processing rule or uses a default data processing rule. This process ensures each first-order operator corresponds to an appropriate data processing rule that is selected based on its data type, to ensure that a data is processed and computed based on a correct rule.

The benefit of this is that, a corresponding data processing rule is selected based on a data type of the first-order operator, to ensure that the type of data matches the data processing rules, and thus inappropriate data processing is avoided; a plurality of options of data processing rules are provided based on data types, and thus flexibility is improved, to adapt to different types of data analysis requirements; matching of a data processing rule ensures accuracy of data processing, each first-order operator is computed based on an appropriate rule, and thus accuracy of analysis is improved; for a user who has a request that it is necessary to generate a custom index, he/she may be more easy to select and configure a data processing rule of a first-order operator, and thus user-friendliness is improved.

In some possible embodiments, after determining the at least one first-order operator and determining the data processing rule corresponding to each first-order operator in the at least one first-order operator, the method further includes: performing the following processing for one or more first-order operators in the at least one first-order operator: determining at least one second-order operator corresponding to the first-order operators, and determining a secondary filtering rule corresponding to each second-order operator in the at least one second-order operator. The second-order operator is the index of basic category or custom category. The generating the custom index based on the at least one first-order operator and the data processing rule corresponding to each the first-order operator, includes: generating the custom index based on the at least one first-order operator and the data processing rule corresponding to each the first-order operator, and the at least one second-order operator and the secondary filtering rule corresponding to each the second-order operator.

For part or all of the first-order operators, a secondary filtration thereof is performed by using second-order operators. The second-order operators are data operational units that are further processed or screened based on the first-order operators and used for data filtering or processing. As an example, the second-order operators may be used for screening patents under a specific classification number, products with sales amount in a city larger than 1000, a stock price of a company for a specific time period, etc.

Secondary filtering rules are those for determining what data will be retained or deleted, and are combined with the second-order operators, to further screen data accurately. As an example, the secondary filtering rules may include screening of data about a specific classification number, data about sales amount larger than 1000, data about a stock price for a specific time period, etc.

The secondary filtration is a process of screening or processing a set of to-be-processed data corresponding to the first-order operators based on the second-order operators and their corresponding secondary filtering rules. As an example, the set of to-be-processed data corresponding to the first-order operators includes patent application data corresponding to all classification numbers, and through the secondary filtration, a subset of data under a specific classification number may be obtained.

After the second-order operators are introduced, the custom indexes are determined based on the first-order operators and their corresponding data processing rules as well as the second-order operators and their corresponding secondary filtering rules. Moreover, part or all of the first-order operators correspond to the second-order operators, in other words, each second-order operator is used for performing the secondary filtration of one first-order operator.

In some embodiments, when a user ticks one index name in an index list, or the mouse hovers over one index name in an index list, an index abstract is displayed in a form of a card or a floating layer, and contents presented in the index abstract include a formula. When formulas corresponding to the custom indexes are displayed, the first-order operators and their data processing rules as well as operation rules among the first-order operators may be displayed. In yet other embodiments, when formulas are displayed, the first-order operators and their corresponding data processing rules as well as the second-order operators corresponding to the first-order operators and their secondary filtering rules, and operation rules among the first-order operators may be displayed. As an example, a formula is as follows: [number of patents (summing) &<receiving office: England, America>]/inventors (de-duplication counting). The number of patents and inventors refer to first-order operators, the receiving office refers to a second-order operator.

Therefore, after the first-order operators and their corresponding data processing rules are determined, one or more of the first-order operators are further updated, and the secondary filtration are performed by adding at least one second-order operator and corresponding secondary filtering rules. In particular, at least one second-order operator corresponding to one or more determined first-order operators is determined. These second-order operators may be generated based on computations of the first-order operators, and are used for further screening, processing, or computing the set of to-be-processed data. For each determined second-order operator, a corresponding secondary filtering rule is determined. These secondary filtering rules specify how to use the second-order operators to further screen or process the set of to-be-processed data corresponding to the first-order operators. Based on the second-order operators and their corresponding secondary filtering rules, the set of to-be-processed data corresponding to the first-order operators can be updated by the secondary filtration, this means that, when the set of to-be-processed data is screened or processed based on the second-order operators and the secondary filtering rules, to perform a process of data processing corresponding to the first-order operators, the pending set of to-be-processed data is no longer the raw set of to-be-processed data, but a set of to-be-processed data after the secondary filtration.

The benefit of this is that, second-order operators and secondary filtering rules are introduced by secondary filtering, a user may control a single first-order operator in aspect of scope, i.e. only a single first-order operator, but analysis of full data, is affected, therefore, more precise data screening and analytical capability is provided, the user may control the scope of data analysis more finely, and thus accuracy and flexibility of data analysis are improved; more complicated data operations may be performed, for example, computation of relative indexes, screening of data under a specific condition, and so on; the user may add or modify the second-order operators and the secondary filtering rules at any time as required, to accommodate to different data analysis scenarios, and thus flexibility and customizability of data analysis are enhanced; the user may get an analysis result in comply with his/her demands more quickly by fine data control and customized processing, and thus efficiency of data analysis is improved.

In some possible embodiments, a process of determining at least one second-order operator corresponding to the first-order operators, includes: receiving one or more second selection operations performed by the user for the index set via a terminal device, to determine one or more second-order operators; or receiving one or more second text entry operations performed by the user via a terminal device, to identify the one or more second-order operators based on received one or more second text entry operations. The determining a secondary filtering rule corresponding to each second-order operator of the at least one second-order operator, includes: (static filtering) receiving third text entry operations and/or third selection operations performed by the user via the terminal device, to determine the secondary filtering rule corresponding to the second-order operator; or (dynamic filtering) receiving type selection operations performed by the user for a set of judgement types via the terminal device, to determine a judgement type corresponding to the second-order operator; receiving fourth text entry operations and/or fourth selection operations performed by the user via the terminal device, to determine the secondary filtering rule corresponding to the second-order operator in combined with the judgement types.

In some possible embodiments, the receiving type selection operations performed by the user for a set of judgement types via the terminal device, to determine a judgement type corresponding to the second-order operator, includes: displaying the set of judgement types corresponding to data types of the second-order operators via the terminal device; the data types of the second-order operators are as follows: the numerical values, the characters, the time, or the geographies; and receiving a type selection operation performed by the user for one judgement type of the set of judgement types, and taking a judgement type selected by the user as that corresponding to the second-order operator.

In some possible embodiments, the set of judgement types corresponding to data types (second-order operators) of the numerical values includes one or more of the following: more than, less than, equal to, no more than, no less than; and/or, the set of judgement types corresponding to data types (second-order operators) of the time includes one or more of the following: before, after; and/or, the set of judgement types corresponding to data types (second-order operators) of the characters includes one or more of the following: including, not including; and/or, the set of judgement types corresponding to data types (second-order operators) of the geographies includes one or more of the following: including, not including.

In some possible embodiments, when a data type of the second-order operators is time, a user's unit text entry operation and/or unit selection operation may also be received via the terminal device, to determine the unit of the time; the secondary filtering rules corresponding to the second-order operators are determined based on fourth text entry operations and/or fourth selection operations in combination with judgement types and the unit of the time.

In some possible embodiments, when number of the second-order operators is larger than 1, the set of to-be-processed data corresponding to the first-order operators is updated by secondary filtering based on the second-order operators corresponding to the first-order operators and their corresponding secondary filtering rules, and operation rules among the second-order operators. The operation rules among the second-order operators for example may be AND, OR, NOT.

The secondary filtering may include the following two filtering methods: static filtering and/or dynamic filtering.

Taking static filtering as an example, it is assumed that it is necessary to analyze sales data of an e-commerce website, firstly, sales data in 2022 is screened as a set of to-be-processed data (may also be called as “a set of to-be-analyzed data”). Next, a user selects one first-order operator, i.e. “sales amounts of products”. The user continues to select a data processing rule “summing”, to perform summing operation on sales amount of each product, to get total sales amounts. Then the user performs a second selection operation, to select one second-order operator, i.e. “sales area”. Afterwards, the user performs a third selection operation and selects “China” and “German”, in order to perform the following secondary filtering rules: sales data of China and German in 2022 is screened from sales data in 2022. After the second-order operators and their corresponding secondary filtering rules are applied to the first-order operators, when a process of data processing corresponding to the first-order operators is performed, the set of to-be-processed data corresponding to the original first-order operator “sales amounts of products” will be updated, to only include sales data of China and German, the data processing result corresponding to the first-order operators (i.e. a sum corresponding to “sales amounts of products”) is no longer the total sales amount of all areas, but of China and German.

Taking dynamic filtering as an example, it is assumed that it is necessary to perform patent data analysis, firstly, granted invention patent data in 2022 is screened as a set of to-be-processed data. Next, a user selects one first-order operator, i.e. “patent value”. The user continues to select a data processing rule “summing”. Afterwards, the user selects “number of patents” and “applicant” from an index list as second-order operators, and selects “OR (or, AND)” as an operator therebetween. For the second-order operator of “number of patents”, the user selects “greater than” from a judgement type list as a judgement type of “number of patents”, and enters “100” as a dynamic filtering threshold, to implement the secondary filtering rule corresponding to this second-order operator: data about number of patents greater than 100 is screened. For a second-order operator of “applicant”, the user selects “before” from the judgement type list as a judgement type of “applicant”, and enters “10” as a dynamic filtering threshold, to implement the secondary filtering rule corresponding to this second-order operator: data about top 10 applicants is screened. Finally, the set of to-be-processed data corresponding to the first-order operators is updated by secondary filtering based on two second-order operators (i.e. “number of patents” and “applicant”) corresponding to the first-order operator (i.e. “patent value”) and their corresponding secondary filtering rules: data about top 10 applicants with number of patents more than 100 is screened. The data processing result corresponding to the first-order operator (i.e. a sum corresponding to “patent value”) is a sum of patent values of granted invention patents in 2022 corresponding to top 10 applicants with number of patents greater than 100.

Therefore, after the first-order operator is determined, at least one second-order operator and a secondary filtering rule corresponding to each second-order operator in the at least one second-order operator are determined, to update the set of to-be-processed data corresponding to the first-order operator.

Firstly, at least one second-order operator is determined, and may be implemented by different methods.

First Method: a user performs second selection operations through a terminal device to select one or more second-order operators.

Second Method: a user performs second text entry operations through a terminal device to automatically identify one or more second-order operators from a text.

Next, a secondary filtering rule corresponding to each second-order operator is determined, which may also be implemented by different methods:

First Method (static filtering): third text entry operations and/or third selection operations are performed by a user through a terminal device, and thus secondary filtering rules are determined. For example, a specific numerical value is entered, or an existed option is selected from a list. Static filtering allows the user to statically screen options based on attributes of parameter values, for example, number of patents of a specific applicant in a specific country, then the first-order operator is “number of patents”, the second-order operator is “receiving office”, the secondary filtering rule represents that data about European and American receiving offices is screened.

Second Method (dynamic filtering): a user performs type selection operations, and selects one judgement type (for example, greater than, less than, equal to, before, after, including, not including) from a set of judgement types, to determine a judgement type corresponding to a second-order operator, and then, fourth text entry operations and/or fourth selection operations are performed by the user through a terminal device, and a secondary filtering rule is determined in combination with judgement types. Dynamic filtering allows a user to screen options based on attributes of parameter values, for example, applicants with number of patents more than 100 are screened, or sellers with top 50 sales amounts are screened.

Finally, the determined secondary filtering rule is applied, the set of to-be-processed data corresponding to the first-order operator is updated by secondary filtering. i.e. the set of to-be-processed data (for example, patent application data of a specific applicant) corresponding to the first-order operator is further screened or processed based on the second-order operator and the secondary filtering rule, such that the set of to-be-processed data is updated. Because the set of to-be-processed data is updated, if a process of data processing corresponding to the first-order operator is performed, the result of the data processing will also change correspondingly.

The benefit of this is that, the user may flexibly select or enter the second-order operators or the secondary filtering rules on the terminal device according to his/her specific requirements and preferences, which increases capability of user-defined analysis; multiple entering methods are supported, including selection operations and text entry operations, which increases methods of interaction between a user and a system, such that the interaction is more easy; the user may select the secondary filtering method such as static filtering or dynamic filtering, etc. to meet different data analysis requirements; the user may select different judgement types as required by introducing a set of judgement types, to better control and customize secondary filtering rules; the user may add or modify second-order operators and rules at any time as required, to accommodate to different data analysis scenarios, and thus flexibility and customizability of data analysis are improved; the user may get an analysis result in comply with his/her requirements more quickly by fine data control and customized processing, to improve efficiency of data analysis.

In some possible embodiments, a process of determining operation rules among the plurality of first-order operators, includes: receiving fifth text entry operations and/or fifth selection operations performed by the user, to determine operation rules among the plurality of first-order operators; or providing a second chatbot human-computer interface by the terminal device, to receive one or more second input information from the user; and extracting semantics from each second input information of the one or more second input information, to determine the operation rules among the plurality of first-order operators.

The process of determining operation rules among the second-order operators is similar with that of determining operation rules among the first-order operators, and will not be repeated again herein.

The operation rules are used to designate operations and precedence among the first-order operators, which may be arithmetic operations, comparison operations, or logical operations, and the operation rules are used for processing and analyzing of data.

The text entry operations are instructions entered by a user from a text entry box. The selection operations are parameters selected by a user through a drop-down list or a tab, etc. For example, the user selects “division” from the drop-down list as an operational symbol between two first-order operators.

The second chatbot human-computer interface is an interface provided by the terminal device, by which the user may have a dialog and interact with a virtual assistant or a chatbot. For example, the user may make specific data analysis requirements to the chatbot, and obtain appropriate operation rules by extracting semantics and deducing. The second input information for example is text information, voice information, image information.

Therefore, when operation rules among the first-order operators are determined, the use's entry operations and/or selection operations may be received, or semantics are extracted through the second chatbot human-computer interface.

The user performs fifth text entry operations and/or fifth selection operations through the terminal device, and may enter and/or select one or more operation rules, by which operational relations among the first-order operators are defined. These operation rules may include operation levels (for example, parentheses) and arithmetic operators (as addition, subtraction, multiplication, division, etc.), comparison operators (as greater, less than, equal to, etc.) and logical operators (as AND, OR, NOT, and so on). The operation rules will be constructed based on the user's entries and selections.

Alternatively, the second chatbot human-computer interface is provided by the terminal device, by which the user may provide the second input information. Semantics are extracted from each the second input information, to identify the user's intentions and operational requirements. The user's utterances may be identified by extracting semantics, and the semantics may be transformed into specific operators and operational levels, such that it is convenient to construct the operation rules.

The operation rules are constructed based on the operators and operation levels, to define the operation relationships among the first-order operators, and are further used for processing and computation of the custom indexes.

The benefit of this is that, the user may define the operation relationships among the first-order operators through intuitionistic text entry operations, selection operations, or natural language human-computer interface, and thus it is more user-friendly; the user's requirements and intentions may be better understood by extracting semantics, such that the user's entries are transformed into appropriate operation rules accurately, and thus the user's experience is improved; the user may make selections from multiple operation rules, including arithmetic, comparison, and logical operators, to meet different operational requirements, and thus diversity and flexibility of operations are enhanced; it is unnecessary for the user to give an insight into grammars of programming or complicated operation rules, he/she may define the operation rules in an intuitive way, and thus the threshold of use is lowered; operation rules, determined based on the user's text entries, selections, or semantics extraction, are usually more accurate and controllable, and therefore human errors or unclear definitions are avoided.

In some possible embodiments, data processing rules corresponding to data types (first-order operators) of numerical values include one or more of the following: averaging, summing, counting, de-duplication counting, maximum, minimum, proportion and cumulating of the numerical values; and/or data processing rules corresponding to data types (first-order operators) of characters include one or more of the following: counting, de-duplication counting; and/or data processing rules corresponding to data types (first-order operators) of time include one or more of the following: counting, de-duplication counting; and/or data processing rules corresponding to data types (first-order operators) of geographies include one or more of the following: counting, de-duplication counting.

In some possible embodiments, the operation rules among the first-order operators include operational levels and one or more of the following: arithmetic operators, comparison operators, and logical operators, the operation levels represent precedence of operations; and/or operation rules among the second-order operators include logical operators.

Therefore, the data processing rules corresponding to the first-order operators are determined, and the operation rules for the first-order operators and the second-order operators are determined.

An index represented by a specific first-order operator is a numerical value. This means that the index contains a digital data, for example, an integer or a decimal. For an index such as a numerical value, selections for a series of data processing rules are provided. These rules include the following contents.

Averaging: computing an average value of numerical values.

Summing: adding numerical values, to get a sum.

Counting: computing number of numerical values.

De-duplication counting: removing duplicated numerical values, and computing number of remaining numerical values.

Maximum: acquiring a maximum in numerical values.

Minimum: acquiring a minimum in numerical values.

Proportion of numerical values: computing proportion of some numerical values in the total numerical values.

Cumulating: computing numerical values cumulatively, and get a cumulative value.

When the first-order operators are of data types such as characters, time, and geographies, the data processing rules include counting, de-duplication counting, etc., deduplication is used for counting, and de-duplication counting is used for counting of number after deduplication.

In addition, selections for the operation rules among the first-order operators and those among the second-order operators are also provided.

Operation levels: for example, parentheses, used for determining precedence of operations.

Arithmetic operators: for example, addition, subtraction, multiplication, division, power, modulo, used for basic mathematical operations of numerical values.

Comparison operators: for example, greater than, less than, equal to, no greater than, no less than, used for comparing different numerical values.

Logical operators: for example, AND, OR, NOT, used for logical operations.

The user may select an appropriate data processing rule and operation rule according to his/her specific analysis requirements, to generate a custom index for making data analysis of numerical value types.

The benefit of this is that, the user may select appropriate data processing rules and operation rules according to his/her specific analysis requirements for numerical values, and thus analysis of numerical values is diversified, and the user can handle numerical values more flexibly; selections for various mathematical and logical operators are provided, such that the user can perform complicated numerical value and logical operations, to meet different analysis scenarios; the user may be easy to perform accurate numerical value statistics and analysis by providing common data processing rules such as averaging, summing, counting, etc. without manual computations; the user may select cumulating rules, such that a custom index of cumulating computation is generated, this is very useful in tracking the trend of data and cumulating data; different data processing rules and operation rules are based on different analysis requirements, which can make the user flexibly customize a custom index, to meet data analysis requirements under different scenarios.

In a specific application scenario, an embodiment of the present application provides a method for generating a custom index, including: determining at least one first-order operator and their corresponding data processing rules, and operation rules among the at least one first-order operator, the first-order operator being an index of basic category or custom category; the operation rules among the at least one first-order operator including operation levels and one or more operators as follows: arithmetic operators, comparison operators, and logical operators, and the operation levels being used for indicating operation precedence; performing the following processing for one or more first-order operators in the at least one first-order operator: determining at least one second-order operator corresponding to the first-order operators and their corresponding secondary filtering rules, the second-order operator being the index of basic category or custom category; and generating the custom index based on the at least one first-order operator and their corresponding data processing rules, and the at least one second-order operator and their corresponding secondary filtering rules, the custom index being of custom category. The custom index can serve as the first-order operator, to generate a new custom index.

The process of determining at least one first-order operator, includes: receiving, by a terminal device, one or more first selection operations performed by a user for an index set, to determine one or more first-order operators; or receiving, by the terminal device, one or more first text entry operations performed by the user, to identify the one or more first-order operators based on received one or more first text entry operations; or importing the one or more first-order operators from an index sharing platform; or providing a first chatbot human-computer interface by the terminal device, to receive one or more first input information from the user; and extracting semantics from each first input information, to determine the one or more first-order operators.

The process of determining a data processing rule corresponding to each first-order operator of the at least one first-order operator, includes: for each the first-order operator, determining one data processing rule of a set of data processing rules as that of the first-order operator based on the set of the data processing rules corresponding to data types of the first-order operators; the data types of the first-order operators are as follows: numerical values, characters, time, or geographies; the data processing rules, corresponding to the numerical values, each as one of the data types, include one or more of the following: averaging, summing, counting, de-duplication counting, maximum, minimum, proportion and cumulating of the numerical values.

The process of determining at least one second-order operator corresponding to the first-order operators, includes: receiving, by the terminal device, one or more second selection operations performed by the user for the index set, to determine one or more second-order operators; or receiving, by the terminal device, one or more second text entry operations performed by the user, to identify the one or more second-order operators based on received one or more second text entry operations.

The process of determining a secondary filtering rule corresponding to each second-order operator, includes: receiving, by the terminal device, third text entry operations and/or third selection operations performed by the user, to determine the secondary filtering rule corresponding to the second-order operator; or receiving, by the terminal device, type selection operations performed by the user for a set of judgement types, to determine a judgement type corresponding to the second-order operator; receiving, by the terminal device, fourth text entry operations and/or fourth selection operations performed by the user, to determine the secondary filtering rule corresponding to each the second-order operator in combined with the judgement types; the judgement types include one or more of the following: greater than, less than, equal to, before, after, including, and not including.

The process of determine a judgement type corresponding to each the second-order operator, includes: displaying, by the terminal device, the set of judgement types corresponding to data types of the second-order operators, the data types of the second-order operators being as follows: the numerical values, the characters, the time, or the geographies; and receiving a type selection operation performed by the user for one judgement type of the set of judgement types, and taking a judgement type selected by the user as that corresponding to the second-order operator

The process of determining operation rules among the plurality of first-order operators, includes: receiving fifth text entry operations and/or fifth selection operations performed by the user, to determine operation rules among the plurality of first-order operators; or providing a second chatbot human-computer interface by the terminal device, to receive one or more second input information from the user; and extracting semantics from each second input information in the one or more second input information, to determine the operation rules among the plurality of first-order operators.

For example, in patent data analysis field, “applicant” is selected as a first-order operator, and the first-order operator of “applicant” may also be filtered, to further select multiple different second-order operators. For example, “specific IPC classification number” is further selected as a second-order operator, upon filtering, it is represented that number of patents of “present applicant” under “specific IPC classification number”, and thus «number of patents of “present applicant” under “specific IPC classification number”» is formed as a new operator, and functional operations with other operators may be performed.

After selecting the first-order operator (for example, patent value), operations with another one index (for example, inventor) may be performed based on operation rules, in particular, “patent value”/“inventor”, may represents an average patent value produced by each inventor, further, “application year”, as a first-order operator, may also be divided by the above-mentioned operation, that is to say, “patent value”/“inventor”/“application year” may also represents an average patent value produced by each inventor in each year.

Operators such as basic indexes and custom indexes are supported, personnels having data analysis requirements (for example, patent analysts) may flexibly perform data statistics and analysis according to different data types and computational requirements. Both counting and de-duplication counting of number of patents, and advanced computation of patent data such as averaging, summing, maximum, minimum, and so on may also be performed quickly and accurately by an index editor, and thus efficiency of data analysis may be improved, more analytical dimensions and methods are also provided, to help patent analysts better understand and apply patent data. In addition, because this method has a characteristic of SQL visualization, the patent analysts may perform data query, screening, and analysis by this method. For example, patent data in comply with conditions is acquired quickly by filtering operations and combining operators according to specific requirements and conditions, to provide accurate and targeted patent information and analysis reports for customers. For patent analysts, this may improve efficiency and accuracy of work greatly, to meet demands of the market for high effective patent analysis services.

Taking a patent data analysis scenario as an example, a user A is a patent analyst, in the initial stage, upon filtering (for example, establishing a search query and executing), the user A obtains a set of to-be-processed data, i.e. a global granted invention patent data from 2012 to 2022.

Through a user graphical interface provided by the index editor, the user A checks a list of basic indexes, selects “citation count” (indexes of basic category) as a first-order operator, and the user A also checks a list of custom indexes, selects “number of patents” (indexes of custom category) as a first-order operator.

In addition, the user A also enters “validity period”, the index editor identifies and matches it with an index of “patent term”, i.e. a third first-order operator.

For “number of patents”, the user A selects “counting” as a data processing rule.

For “citation count”, the user selects “averaging”, to evaluate influence of these patents.

For “patent term”, the user selects “averaging”, to check average patent term in this field.

The user A wants to further analyze proportions of technical contribution of different applicants in a specific technical field, therefore, for the above-mentioned three first-order operators, two second-order operators are provided respectively. The user A selects “applicant” as a second-order operator, and adds “classification number” as a second second-order operator by entering a text.

For “applicant”, the user A selects a judgement type “including”, and enters a key word such as a specific applicant, to filter specific patents.

For “classification number”, the user A selects a judgement type “including”, and enters s specific patent classification number.

The user A selects to perform logarithmic processing (taking natural number e as a base) of “number of patents” through an interface, afterwards, multiplies it with “citation count”, and again multiplies “patent term”, to evaluate degree of acceptance of the market for this technical field.

Finally, a custom index is generated by the index editor based on selections and entries of the user A, and the user A names it as “degree of acceptance of the market”, this custom index helps the user A to assess trend of a certain technical field in the market, degree of activity of research and development, and its potential in the market. Based on the above-mentioned method for generating a custom index, a patent analyst such as the user A can deeply and fully evaluate trend and potential of the technical field without complicated procedure programming.

Taking an e-commerce data analysis scenario as an example, a user B is an e-commerce data analyst, and use an index data editor of an e-commerce data analysis system to analyze sales effect of his/her on-line stores. In the initial stage, upon filtering, the user B obtains a set of to-be-processed data, i.e. e-commerce sales data of on-line stores in 2022.

The user B selects “sales amount” and “purchase quantity” as first-order operators.

In addition, the user B also enters “refund amount”, the index editor identifies and adds an index of “refund amount” as the third first-order operator.

For three indexes of numerical values such as “sales amount”, “refund amount”, and “purchase quantity”, the user B selects “summing” as a data processing rule.

The user B decides to further analyze proportion of sales amount of what product categories to total sales amounts is high, and selects “product category” as a second-order operator of three first-order operators.

For “product category”, the user B selects a “including” rule, and enters a “electronic product” as a filtering condition.

Through interaction with a second chatbot, the user B enters: “sales amount minus refund is divided by sales quantity”. The second chatbot identifies and sets corresponding operation rules: “sales amount” minus “refund amount” is divided by “purchase quantity”.

After all these steps are completed, a custom index “average selling price” is generated by the index editor based on the user B's selections and entries, and the custom index represents purchasing power of customers in this online store.

In some embodiments, the method also includes: testing a formula corresponding to the custom index, to obtain a testing result, the testing result indicating whether the formula is correct. Or the testing result represents whether the formula is accepted.

Therefore, not only accuracy of data, but also stability and reliability of a data processing process are ensured by testing the formula corresponding to the custom index. In particular, deep analysis of the formula corresponding to the custom index is performed in a formula testing process to ensure that mathematical errors such as dividing by zero in a formula and other incomputable problems (for example, logical errors) are avoided. When such problems exist in this formula, the testing result will immediately report that the formula is error. The benefit of this is that, not only accuracy of data analysis is improved, but also user-friendliness of a platform is enhanced greatly; the user may correct potential errors quickly by testing the formula in time, and thus a high reliability of analysis is ensured, and a large amount of time and resources are saved; in addition, the whole stability of a data analysis platform is improved, such that when challenged with complicated data processing tasks, the platform can be efficient and stable.

The method for testing a formula is not limited in the present application, for example, a formula testing model based on deep learning.

In some embodiments, the method further includes: generating an improved prompt message corresponding to the custom index and displaying it on the terminal device when the formula is wrong.

Therefore, an immediate guidance is provided for a user by a real-time feed-back mechanism, to help the user modify and optimize the formula corresponding to the custom index more quickly and more precisely. In addition, these prompt messages are not only limited to simple error indications, but also specific modifying suggestions, common error cases, and relevant interpretations of mathematical principles are included, to enhance the user's understand for data and formula logic, and thus same errors are avoided in the future. The benefit of this is that, a user's experience is improved, even for a user who is not familiar with a complicated mathematical formula, he/she can also customize and adjust a formula in the index editor; moreover, it is not necessary for the user to look up a manual frequently or appeal for a support personnel by intelligent prompt; this real-time feedback and suggesting mechanism not only increases accessibility of the platform, but also help to train a user's ability of analyzing data, and scenarios and audiences for the use of the indicator editor are further expanded.

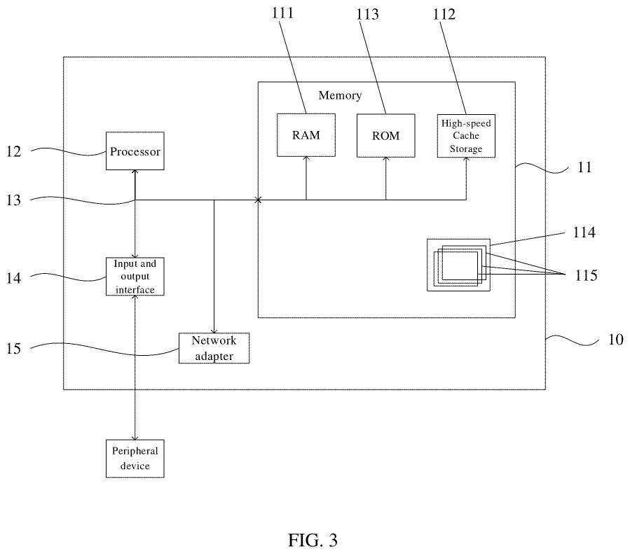

With reference to FIG. 2, FIG. 2 is an interface schematic diagram of an index editor according to an embodiment of the present application.

The present application provides an index editor used to provide a custom index generating interface, including: a combo box configured to receive first text entry operations and/or first selection operations performed by a user, to determine at least one first-order operator; a formula edit box configured to display each first-order operator determined by the user in the form of an operator control, and to receive rule selection operations performed by the user for a drop-down list box in the operator control, to determine a data processing rule corresponding to each first-order operator; an index generating button configured to generate a custom index based on the at least one first-order operator and the data processing rule corresponding to each the first-order operator upon being clicked, the custom index being of a custom category. The custom index can serve as the first-order operator, to generate a new custom index.

In some possible embodiments, the operator control further includes: a secondary filter configured to determine at least one second-order operator corresponding to the first-order operator and a secondary filtering rule corresponding to each second-order operator.

In some possible embodiments, the custom index generating interface further includes: a tooltip control configured to display a prompt message corresponding to the formula edit box when a mouse hover operation is received.

The combo box is a composite control formed by a list or a drop-down list and a single-line editable text box in a computer graphical user interface, which allows a user to directly enter a value from a keyboard or select a value from a list. The combo box allows the user to perform first text entry operations and/or first selection operations, to determine at least one first-order operator. The user may select one or more first-order operators from indexes of basic categories or custom categories as a basis for constructing custom indexes. The combo box, for example, may include a text box and a list box, to support both the list box and the user's text entries. As an example, the user may enter “applicant” into or select “applicant” from the combo box.

The formula edit box is an interface element used to display each first-order operator selected by a user as well as their corresponding data processing rules and operation rules. The user may set a rule corresponding to each first-order operator and an operation rule herein. As an example, the user may provide a custom formula such as “sales amount-refund” in the formula edit box.

The formula edit box displays each first-order operator determined by the user in the form of operator control. In the operator control, the user may select a data processing rule corresponding to each first-order operator, the data processing rule indicates how a data analysis system executes a data processing process corresponding to selected operator. Different data processing rules may applied to indexes of different types, for example, numerical values, characters, time, or geographies.

The formula edit box is further used to receive fifth text entry operations and/or fifth selection operations performed by the user, to determine operation rules among the plurality of first-order operators. The user may also select different operation rules, for example, operation levels, and arithmetic operators, comparison operators, or logical operators, to define data relationships, operation order, operational precedence among the first-order operators.

The operator control refers to an interface element, used to display and manage each first-order operator, in the formula edit box, which includes a drop-down list box. The user may provide a data processing rule for an operator in the operator control. As an example, the user may select “summing” from the operator control as a data processing rule.

The operator control further includes a secondary filter used to further refine data processing and screening. Through a secondary filter, the user may determine at least one second-order operator corresponding to the first-order operator and their corresponding secondary filtering rules, to help the user perform a secondary filtration on a set of to-be-processed data. As an example, the user may select “product category” from the secondary filter as a second-order operator, and provide the secondary filtering rules as “including” +“mobile phone OR computer OR tablet OR watch OR bracelet”, to screen records relevant with “electronic product” from sales data.

The set of to-be-processed data refers to raw data which is analyzed and processed by a user. As an example, the set of to-be-processed data includes e-commerce sales data of the on-line stores in 2022, including information such as sales amount, purchase quantity, refund amount, etc.

The tooltip control is an interface element, used to display additional information or interpretations when a mouse hovers over the tooltip control. In the index editor, the tooltip control is used to provide relevant information with the first-order operators, to help the user better understand and select operators. As an example, when the user makes a mouse hover over “sales amount” operator by the operator control, the tooltip control will display a message, such as “sales amount represents revenue of on-line stores”. As an example, the icon of the tooltip control indicates “i” (as shown in FIG. 2).

The benefit of this is that, an intuitionistic interface is provided, a user may select a first-order operator easily and define a data processing rule and an operation rule without programming and complicated operations; the formula edit box displays the first-order operator and the operation rule selected by the user in a form of operator control, such that the user can clearly understand how a custom index is constructed; the user may select an appropriate data processing rule corresponding to a data type from a drop-down list box, to ensure that the data processing rule is applied to the data type of the selected first-order operator, such that accuracy of data processing is improved; the user may select different operation rules as required, to determine data relationships among the first-order operators, and seek different ways of analyzing data; the user may understand how his/her selections affect generation of a custom index at any time, and thus understand whether a result meets its actual demands quickly; probability of definitions which are wrongly made by the user is reduced through a user-friendly interface, and thus accuracy of analyzing data is improved; creation and edition of a custom index becomes more quick and simple, and thus efficiency of work is improved, such that the user can analyze data and decide more rapidly.

The user may manage the first-order operators and their relevant second-order operators and secondary filtering rules by providing a secondary filter in the operator control. The second-order operators are used to further refine or filter data about the first-order operators. The user defines a secondary filtering rule for each second-order operator through the secondary filter, these secondary filtering rules indicate how a system uses the second-order operators to process data about the first-order operators. The secondary filtering rules may include conditions, operations, and parameters. After at least one second-order operator and corresponding secondary filtering rules are determined, the system will update a set of to-be-processed data corresponding to the selected first-order operator by secondary filtering, and the set of to-be-processed data corresponding to the first-order operator will be affected by the second-order operator and corresponding secondary filtering rule. The benefit of this is that, the user is allowed to use the second-order operator and corresponding secondary filtering rule to further process data about the first-order operators precisely, and global data analysis is not affected, and thus more specific and useful analysis results are obtained; the user may filter unnecessary data by defining secondary filtering rules, and thus noises and complexity of data are reduced, quality of data analysis is improved; data may be further refined, such that a certain aspect of data is deeply understood, and multi-dimensional support for a decision is provided; probability of definitions which are wrongly made by the user is reduced through a user-friendly interface, and thus accuracy of analyzing data is improved; the user is allowed to manage the first-order operators and the second-order operators and corresponding rules in a interface, such that data analysis and processing are more quick and simple.

The tooltip control is intended to provide information for a user, such that the user understand usage and functions of the formula edit box. When the user makes a mouse hover over the tooltip control, a prompt message will be triggered and displayed. The prompt message includes a text about descriptions, uses, and functions of the first-order operators (or corresponding second-order operators) in the formula edit box, and the information helps the user better understand meanings of each link and each constitutional portion of the formula edit box, such that informed decisions may be made in selecting and configuring the operator. When the user hovers a mouse over the tooltip control, the user can acquire information relevant with the formula edit box as required without leaving the current interface or consulting documentation. The benefit of this is that, it helps a user to understand functions and usage of the formula edit box by a prompt message, such that the user can better select appropriate operators and rules; it helps the user to reduce risk of making incorrect selections or configurations for not understanding operators, and thus potential errors are reduced; perception for the first-order operators and confidence for data analysis results are enhanced, such that the user is more willing to use and seek data processing tools; it allows the user to acquire information quickly when a mouse hovers over without additional steps or queries; a new user is more easy to understand and use a system.

In a specific application scenario, an embodiment of the present application provides an index editor used to provide a custom index generating interface, including: a combo box configured to receive first text entry operations and/or first selection operations performed by a user, to determine at least one first-order operators; a formula edit box configured to display each first-order operator determined by the user in the form of an operator control, and to receive rule selection operations performed by the user for a drop-down list box in the operator control, to determine a data processing rule corresponding to each the first-order operator; an index generating button configured to generate a custom index based on the at least one first-order operator and the data processing rule corresponding to the first-order operator upon being clicked, the custom index being of custom category; a tooltip control configured to display a prompt message corresponding to the formula edit box when a mouse hover operation is received; the custom index can serve as the first-order operator, to generate a new custom index; in addition to a drop-down list box, the operator control further includes a secondary filter. The secondary filter is configured to determine at least one second-order operator corresponding to the first-order operator and a secondary filtering rule corresponding to each the second-order operator. Moreover, the index generating button is configured to generate a custom index based on the at least one first-order operator and the data processing rule corresponding to each first-order operator, the at least one second-order operator and the secondary filtering rule corresponding to each the second-order operator upon being clicked.

As an example, it is necessary for a user C to assess degree of activity of research and development in a certain technical field. The user C logs in a data analysis platform, clicks “Create a custom index” and enters into a custom index generating interface provided in an index editor. The custom index generating interface includes an index name text input box, a combo box, a formula edit box, an index generating button, a tooltip control, a descriptive text input box. The index name text input box is used to input an index name. The descriptive text input box is used to input descriptive information.

The combo box includes a search text input box and a list box, the list box employs a hierarchical list including three sub-lists, which are respectively “My favorites”, “Basic indexes”, “Custom indexes”. When the user C clicks names in each sub-list, a corresponding sub-list will be displayed.

The user C enters “patent value” into the search text input box as a first text input operation, to determine “patent value” as a first-order operator. The formula edit box on the right of the combo box shows determined first-order operator “patent value (US dollar)”. A drop-down list box is provided in the operator control. The user C clicks the drop-down list box, and a series of data processing rules are presented, such as “averaging”, “summing”, “counting”, etc. The user C selects “summing” rule, and enters “*7.2” on the right of the first-order operator, to represent that US dollar will be converted into RMB.

The user C continues to enter “/”, representing a division operator.

The user C then selects “inventor” from the combo box as a second first-order operator, and selects “de-duplication counting” from an operator control corresponding to “inventor” as a data processing rule of the first-order operator.

The user C continues to enter “/”, representing a division operator.

The user C then selects “year of application” from the combo box as a third first-order operator, and selects “de-duplication counting” as a data processing rule of the first-order operator.

Next, the user C enters: annual value of inventors per capita (RMB) in the index name text input box.

A secondary filter icon is also provided in each operator control, the user C clicks a secondary filter corresponding to a first-order operator of “patent value (US dollar)”, sets a second-order operator “receiving office”, and selects “Russia”, “England”, “Europe”, to perform the following secondary filtering rule: screening Russia, England, Europe as receiving offices.

Afterwards, the user Centers: the index represents patent value produced by each inventor in each year in the descriptive text input box.

In the formula edit box, position (or sequence) of each first-order operator in a formula is adjusted by dragging.

Moreover, at the left bottom of the formula edit box, computing time for analyzing the index may be shown in real-time (for example, 3.9 s).

Moreover, when the user C makes a mouse hover over the tooltip prompt control, a prompt message corresponding to the formula edit box will be shown, such as “Click index creation formula on the left”.

After the above-mentioned operations are completed, the user C clicks “Generate an index” (or “Save”, “Submit”) button on an interface. Based on first-order operators and corresponding data processing rules and operation rules among the first-order operators selected by the user C, a new custom index “annual value of inventors per capita (RMB)” is generated.

The custom index after editing will present in the first place of a sub-list corresponding to the custom index. When the user C makes a mouse hover over the custom index, abstract contents (i.e. index abstract) of the custom index will be shown on the right of the custom index in a form of a floating window, including an index name, an operation formula, an index interpretation, updating date, creation date, etc. The custom index after editing can be edited and deleted again.

An embodiment of the present application provides an electronic device, its detailed description is similar with the above-mentioned embodiments and technical effect, and part of contents will not be repeated again.

The electronic device includes a memory and at least one processor, a computer program is stored on the memory, and when executing the computer program, the at least one processor is configured to perform steps of any of the above-mentioned methods or functions of any of the above-mentioned index editors.

In some embodiments, the electronic device includes a processor connected by a system bus, a non-transitory storage medium, a memory, a communication interface, a display apparatus, and an input apparatus. Operating systems and relevant computer programs may be stored on the non-transitory storage medium.

With reference to FIG. 3, FIG. 3 is a structural block diagram of an electronic device 10 according to an embodiment of the present application.

The electronic device 10 may include at least one memory 11, at least one processor 12, and a bus 13 connecting different platforms.

It should be appreciated that, the memory 11 in the specification may be a transitory storage or a non-transitory storage, or may include both a transitory storage and a non-transitory storage. The non-transitory storage may be a Read-Only Memory (ROM) 13, a Programmable Read-Only Memory (Programmable ROM, PROM), an Erasable Programmable Read-Only Memory (Erasable PROM, EPROM), an Electrically Erasable Programmable Read-Only Memory (EEPROM), or a Flash Memory. The transitory storage may be a Random Access Memory (RAM) 111. It should be noted that, the memory 11 according to the product and method descripted herein is intended to include, but not limited to these and any other appropriate memories. As an example, the memory 11 includes a Random Access Memory (RAM) 111, a High-speed Cache storage 112, and a Read-Only Memory (ROM) 113. A computer program is stored on the memory 11, when executed by the processor 12, the computer program will cause the processor 12 to perform steps of aby of the above-mentioned methods. The memory 11 may also include a utility 114 having at least one program module 115 thereon, the program module 115 includes, but not limited to: an operating system, one or more applications, other program modules and programming data, the exemplified one or more combinations may include establishment of networks.

Correspondingly, the processor 12 may execute the above-mentioned computer program, and may execute the utility 114. It should be understood that, the processor 12 in the specification may be an integrated circuit chip having a capacity of processing signals. In an implementation, steps of the above-mentioned methods may be completed by the processor 12, for example, by an integrated logical circuit in a form of hardware or instructions in a form of software. The processor 12 may be a General-Purpose Processor, a Digital Signal Processor (DSP), an Application Specific Integrated Circuit (ASIC), A Field Programmable Gate Array (FPGA), a Programmable Logic Controller (PLC), a Complex Programmable Logic Device (CPLD), or other Programmable Logic Devices, a separate gate or a transistor logic device, a separate hardware component, may carry out or perform methods, steps, and logical block diagrams as disclosed in the specification. The General-Purpose Processor may be a microprocessor, or also may be any common processor, etc. Steps of methods as disclosed in the specification may be directly embodied in a decoding processor in a form of hardware or a combined module of hardware and software of the decoding processor. The software module may be in a storage medium such as the Random Access Memory (RAM) 111, the Flash Memory, the Read-Only Memory (ROM) 113, the Programmable Read-Only Memory (Programmable ROM, PROM), the Electrically Erasable Programmable Read-Only Memory (EEPROM), a register, etc. The storage medium is in the memory 11, information is read from the memory 11 by the processor 12, and steps of the above-mentioned methods are performed in combined with its hardware.

The bus 13 may include one or more bus structures, such as a memory bus or a memory controller, a peripheral bus, an Accelerated Graphics Port, a processor, or a local bus using any bus structure.

The electronic device 10 may also communicate with one or more peripheral devices such as a keyboard, a mouse, a pointing device, a Bluetooth device, etc., may also communicate with one or more devices which can interact with the electronic device 10, and/or communicates with any device (for example, a router, a modem, etc.) by which the electronic device 10 can communicate with one or more other computer devices. The communication may be performed by an input and output interface 14. Moreover, the electronic device 10 may also communicate with one or more networks (for example, a local area network (LAN)), a wide area network (WAN), and/or a common network (for example, internet) by a network adapter 15. The network adapter 15 may communicate with other modules of the electronic device 10 by the bus 13. It should be noted that, although not shown in the drawings, in actual applications, the electronic device 10 may be combined with other hardware and/or software modules, including but not limited to, a microcode, a device driver, a redundant processor, an external disk driving array, RAID system, a tape driver, and a data backup storage platform, etc.

An embodiment of the present application provides a computer readable storage media, its detailed description is similar with the above-mentioned methods and technical effect, and part of contents will not be repeated again.

A computer program is stored on the computer readable storage media, when executed by at least one processor, the computer program will cause the at least one processor to perform steps of any of the above-mentioned methods or functions of any of the above-mentioned index editors.

An embodiment of the present application provides a computer program product, its detailed description is similar with the above-mentioned methods and technical effect, and part of contents will not be repeated again.

The computer program product includes a computer program, when executed by at least one processor, the computer program will cause the at least one processor to perform steps of any of the above-mentioned methods or functions of any of the above-mentioned index editors.

The computer program product may include a portable compact disk read-only memory (CD-ROM) and a program code, and may be executed on a terminal device, for example, a personal computer. However, the computer program product in the specification is not limited hereto, and may employ any combination of one or more computer readable mediums.

User information or user account information (including but not limited to user device information, user personal information, etc.) and data (including but not limited to analysis data, stored data, etc.) involved in many embodiments of the present application, are authorized by the user of fully authorized by each party, and collection, use, and processing of relevant data are complied with relevant legal provisions and standards of countries and areas, and corresponding operating entries are provided, such that the user can select to authorize or refuse.

It should be understood that, specific examples of the present specification are only intended to help those skilled in the art better understand embodiments of the present application, not to limit the scope of present application.

It should be understood that, in each embodiment of the specification, sequence of numbers in each process does not represent any order for executing, the executing order is determined by functions and internal logics, processes of the present application are not limited thereto.

It should be understood that, embodiments of the specification each may be implemented alone or dependently, the present application is not limited thereto.

All technological and science terminologies used herein are same with that understood by those skilled in the art, unless otherwise specified. Terms used herein are only for the purpose of describing specific embodiments, not intended to limit the scope of the specification. Terms “and/or” used herein includes any or all combinations of one or more relevant listed items. singular forms such as “a/an”, “the”, and “this” used in the specification and the accompanied claims are also intended to include plural forms, unless otherwise specified in the context.

It should be appreciated by those skilled in the art, units and steps according to embodiments of the present application can be performed by an electronic hardware, or a combination of a computer software and an electronic hardware. These functions may be implemented in form of a hardware or software, which is dependent on specific applications and constrained conditions of technical approaches. For each specific application, the professional personnels may use different methods to carry out the described functions, however, the methods should not exceed the scope of the specification.

Those skilled in the art would be clearly appreciated that, for the purpose of describing conveniently and concisely, corresponding processes of the above-mentioned methods may be referred to for specific processes of the above-mentioned systems, devices, and units, and will not be repeated again herein.

It should be noted that, in some embodiments of the specification, the disclosed systems, devices, and methods may be implemented by other forms. For example, the above-mentioned devices are only illustrative, for example, the units are only divided based on logical functions, however, actually, may be divided based on other functions, for example, multiple units or components may be combined and integrated into another system, or some features may be ignored, or not executed. Moreover, the illustrated or discussed coupling or direct coupling or communication connecting may be implemented electrically, mechanically, or by other forms through some interfaces, devices, or units.

Units as illustrated by separate components may be or may not be separated physically, components as illustrated by units may be or may not be physical units, i.e. may be located at one position, or mat be distributed onto multiply network units. Approaches of the present embodiment may be realized by part or all units according to actual requirements.

In addition, functional units according to embodiments of the specification may be integrated into one single processing unit, may also be existed physically, or two or more units may also be integrated into one single unit.

The functions may be stored in a computer readable storage media when implemented by the form of a software and sold and used as an independent product. Based on this, the technical solution of the specification intrinsically or portion contributing to the prior art or portion of the technical solution may be embodied in the form of a software, the computer software product is stored in a storage medium, includes several instructions, to cause a computer device (may be a personal computer, a server, or a network device, etc.) perform all or part steps of the methods according to embodiments of the specification. However, the above-mentioned storage medium includes: U disk, a portable hard disk, a Read-Only Memory (ROM), a Random Access Memory (RAM) 111, a disk or a CD, etc., to store a program code.

Detailed description above is made to the specification, however, the scope of the present application is not limited thereto, changes or substitutions that would be easy to think of for those skilled in the art, should fall within the scope of the specification. Therefore, the scope of the specification should be governed by that of the claims.

1. A method for generating a custom index, comprising:
determining at least one first-order operator, and determining a data processing rule corresponding to each first-order operator in the at least one first-order operator, the first-order operator being an index of basic category or custom category; and
generating the custom index based on the at least one first-order operator and the data processing rule corresponding to each first-order operator, the custom index being an index of the custom category,
wherein the custom index is capable of serving as the first-order operator, to generate a new custom index.

2. The method for generating the custom index according to claim 1, wherein the determining at least one first-order operator comprises:
receiving one or more first selection operations performed by a user on an index set via a terminal device, to determine one or more first-order operators.

3. The method for generating the custom index according to claim 1, wherein the determining a data processing rule corresponding to each first-order operator in the at least one first-order operator comprises:
performing the following processes on each first-order operator:
determining, based on a set of data processing rules corresponding to a data type of the first-order operator, one data processing rule in a set of data processing rules as the data processing rule of the first-order operator, wherein the data type of the first-order operators is numeric, character, time, or geography; data processing rules corresponding to the numerical value comprise one or more of the following: averaging, summing, counting, de-duplication counting, maximum, minimum, value proportion and accumulation.

4. The method for generating the custom index according to claim 1, wherein after determining the at least one first-order operator and determining the data processing rule corresponding to each first-order operator in the at least one first-order operator, the method further comprises:
performing the following processes on one or more first-order operators in the at least one first-order operator:
determining at least one second-order operator corresponding to the first-order operators, and determining a secondary filtering rule corresponding to each second-order operator in the at least one second-order operator, the second-order operator being an index of basic category or custom category,
wherein the generating the custom index based on the at least one first-order operator and the data processing rule corresponding to each the first-order operator, comprises:
generating the custom index based on the at least one first-order operator and the data processing rule corresponding to each the first-order operator, and the at least one second-order operator and the secondary filtering rule corresponding to each the second-order operator.

5. The method for generating the custom index according to claim 4, wherein the determining at least one second-order operator corresponding to the first-order operators, comprises:
receiving one or more second selection operations performed by the user for the index set via a terminal device, to determine one or more second-order operators; or
receiving one or more second text entry operations performed by the user, to identify the one or more second-order operators based on received one or more second text entry operations via a terminal device,
wherein the determining a secondary filtering rule corresponding to each second-order operator in the at least one second-order operator, comprises:
receiving third text entry operations and/or third selection operations performed by the user via a terminal device, to determine the secondary filtering rule corresponding to the second-order operator; or
receiving a type selection operation performed by the user on a set of judgement types via a terminal device, to determine a judgement type corresponding to the second-order operator; receiving a fourth text entry operation and/or a fourth selection operation performed by the user via the terminal device, to determine the secondary filtering rule corresponding to the second-order operator in combined with the judgement types.

6. The method for generating the custom index according to claim 5, wherein the receiving a type selection operation performed by the user on a set of judgement types, to determine a judgement type corresponding to the second-order operator, comprises:
displaying the set of judgement types corresponding to data types of the second-order operators via the terminal device; the data type of the second-order operator being: numeric, character, time, or geography; and
receiving a type selection operation performed by the user on one judgement type in the set of judgement types, and taking a judgement type selected by the user as a judgement type corresponding to the second-order operator.

7. The method for generating the custom index according to claim 1, wherein when the at least one first-order operator comprises a plurality of first-order operators, the method further comprises:
determining operation rules among the plurality of first-order operators;
wherein the generating the custom index based on the at least one first-order operator and the data processing rule corresponding to each first-order operator, comprises:
generating the custom index based on the plurality of first-order operators, the data processing rule corresponding to each the first-order operator, and the operation rules among the plurality of first-order operators.

8. The method for generating the custom index according to claim 7, wherein the operation rules among the plurality of first-order operators comprise an operation order and one or more operators as follows: arithmetic operator, comparison operator, and logical operator, and the operator order is used for indicating an operational precedence;
wherein the determining operation rules among the plurality of first-order operators, comprises:
receiving a fifth text entry operation and/or a fifth selection operation performed by the user, to determine operation rules among the plurality of first-order operators.

9. The method for generating the custom index according to claim 1, further comprising:
checking an index formula corresponding to the custom index, to obtain a check result, wherein the check result indicates whether the formula is correct or incorrect.

10. The method for generating the custom index according to claim 9, further comprising:
generating a correction prompt information corresponding to the custom index and displaying the correction prompt information on the terminal device when the formula is incorrect.

11. The method for generating the custom index according to claim 1, further comprising:
using an index editor to provide a custom index generating interface, wherein the custom index generating interface comprises:
a combo box, configured to receive first text entry operations and/or first selection operations performed by a user, to determine at least one first-order operators;
a formula edit box, configured to display each first-order operator in the at least one first-order operator determined by the user through an operator control, and to receive rule selection operations performed by the user for a drop-down list box in the operator control, to determine a data processing rule corresponding to each first-order operator;
an index generating button, configured to generate a custom index based on the at least one first-order operator and the data processing rule corresponding to each first-order operator upon being clicked, the custom index being of custom category;
wherein the custom index is capable of serving as the first-order operator, to generate a new custom index.

12. The method for generating the custom index according to claim 11, wherein the operator control further comprises:
a secondary filter, configured to determine at least one second-order operator corresponding to the at least one first-order operator and a secondary filtering rule corresponding to each second-order operator in the at least one second-order operator.

13. The method for generating the custom index according to claim 11, wherein the custom index generating interface further comprises:
a tooltip control, configured to display a prompt information corresponding to the formula edit box when a mouse hover operation is received.

14. An electronic device, comprising a memory and at least one processor, wherein the memory stores a computer program therein, and the at least one processor is configured to execute the computer program, to perform steps of the method according to claim 1.

15. A non-transitory computer readable storage medium, storing a computer program thereon, wherein when executed by at least one processor, the computer program causes the at least one processor to perform steps of the method according to claim 1.

16. The method for generating the custom index according to claim 1, wherein the determining at least one first-order operator comprises:
receiving one or more first text entry operations performed by the user via a terminal device, and identifying one or more first-order operators based on received one or more first text entry operations.

17. The method for generating the custom index according to claim 1, wherein the determining at least one first-order operator comprises:
importing one or more first-order operators from an index sharing platform.

18. The method for generating the custom index according to claim 1, wherein the determining at least one first-order operator comprises:
providing a first chatbot human-computer interface via a terminal device, to receive one or more first input information from a user; and extracting semantics from the one or more first input information, to determine the one or more first-order operators.

19. The method for generating the custom index according to claim 7, wherein the operation rules among the plurality of first-order operators comprise an operation order and one or more operators as follows: arithmetic operator, comparison operator, and logical operator, and the operator order is used for indicating an operational precedence,
wherein the determining operation rules among the plurality of first-order operators, comprises:
providing a second chatbot human-computer interface via the terminal device, to receive one or more second input information from the user; and extracting semantics from each second input information in the one or more second input information, to determine the operation rules among the plurality of first-order operators.

20. The method for generating the custom index according to claim 1, further comprising:
performing data processing on a set of to-be-processed data based on the custom index to obtain data analysis result of the set of to-be-processed data,
wherein the to-be-processed data comprises patent data, and the first-order operator comprises at least one of the following:
receiving office, applicant, inventor, agency, patent agent, application date, grant date, priority date, application number, publication number, patent abstract, patent title, patent type, patent classification number, citations, number of claims, first claim, patent legal status, international patent classification, patent examiner, patent priority, patent litigation information, patent transfer information, citation count for a patent, backward citation count for a patent, patent family members, patent technology field classification, or patent application field classification.
